(19) United States
(12) Patent Application Publication
(10) Pub. No.: US 2022/0178141 A1
(43) Pub. Date: Jun. 9, 2022

(54) A RELEASABLE FASTENING ARRANGEMENT

(71) Applicant: Eazy Coating Electric AB, Huddinge (SE)

(72) Inventors: Håkan Johan Löfholm, Huddinge (SE); Patrik Härnman, Linköping (SE); Taisto Kalevi Nyström, Nyköping (SE)

(73) Assignee: Eazy Coating Electric AB, Huddinge (SE)

(21) Appl. No.: 17/601,132

(22) PCT Filed: Apr. 10, 2020
(86) PCT No.: PCT/SE2020/050379

§ 371 Date: Oct. 4, 2021

(30) Foreign Application Priority Data
Apr. 11, 2019 (SE) 1950456-2

(51) Int. Cl. E04C 2/52; F24D 13/02; F16B 5/06; H01R 13/627; H01R 13/73; H01R 12/77

(52) U.S. Cl. CPC E04C 2/526; F24D 13/024; F16B 5/0607; E04C 2/525; E04C 2002/004; H01R 13/73; H01R 12/774; F16B 2005/0678; H01R 13/6273

(57) ABSTRACT

A first unit (100) including a first member (110) of a releasable fastening arrangement (300) is presented. The releasable fastening arrangement (300) is arranged to provide a mechanical connection of the first unit (100) to a second unit (200), and an electrical connection of a first electrical circuit (120) included in the first unit (100) to a second electrical circuit (220) included in the second unit (200), when a male profile (115) of the first member (110) is inserted into a corresponding female profile (215) included in a second member (210) of the second unit (200). The mechanical connection is provided based one or more at least partially resilient latching arm members (117) of the male profile (115) engaging with one or more corresponding slots (217) of the corresponding female profile (215). The electrical connection is provided by contact between one or more first flexible conductors (124) arranged on a first flexible and electrically insulating layer (126) of the first electrical circuit (120) and one or more second flexible conductors (224) arranged on a second flexible and electrically insulating layer (226) of the second electrical circuit (220).

### FIELD OF INVENTION

The present invention relates to a releasable fastening arrangement that provides a mechanical connection and an electrical connection between two units. In particular, the invention relates to a unit including a member of such a releasable fastening arrangement as defined in the preamble of claim 1 or 2. The present invention also relates to a unit assembly comprising at least one such unit.

### BACKGROUND OF INVENTION

The following background information is a description of the background of the present invention, which thus not necessarily has to be a description of prior art.

A wide variety of fastening arrangements providing a mechanical connection between two units are available in the market, with different types of fastening arrangements used in different areas. In some areas it is desirable to, in addition to the mechanical connection, provide an electrical connection between the two units. One such example is where the two units are floor panels including heating which is electrically generated. To provide heating over a floor including such floor panels, each floor panel needs to be both mechanically and electrically connected to some of its neighboring floor panels. The electrical connection is typically provided with one or more electric connectors arranged between the floor panels, where the electric connectors are connected to the electric circuit in respective floor panel. Other such examples include essentially any type of devices/elements/equipment/arrangements that are to be mechanically and electrically connected together.

### SUMMARY OF INVENTION

Conventional solutions providing an electrical connection between two units, when the two units are mechanically coupled to each other, typically uses separate electric connector(s). These solutions are usually complex and requires special working moments and/or special equipment to couple the electric connector to the electric circuits of each unit, respectively. Furthermore, conventional electric connectors are designed to give a good electric connection but does not provide any mechanical force other than holding the connector pins together. Conventional electric connectors are therefore not suitable to mechanically lock components together.

In addition, the use of separate mechanisms to provide the mechanical connection and the electrical connection between the two units makes both the manufacturing and the installation of the units complicated.

Consequently, there is a need to provide a releasable fastening arrangement which provides both a mechanical and electrical connection between two units without any separate electric connector.

It is therefore an object of the present invention to provide a first unit including a first member of a releasable fastening arrangement, a second unit including a second member of a releasable fastening arrangement, and a unit assembly that solve at least some of the above stated problems and/or disadvantages.

The object is achieved by the above mentioned first unit according to the characterizing portion of claim 1. The first unit includes a first member of a releasable fastening arrangement arranged for providing:
a mechanical connection of the first unit to a second unit; and
an electrical connection of a first electrical circuit included in the first unit to a second electrical circuit included in the second unit;

characterized by:
at least one male profile of the first member, the at least one male profile including one or more at least partially resilient latching arm members arranged for engaging with one or more corresponding slots of at least one corresponding female profile included in a second member of the second unit when the at least one male profile is inserted into the at least one female profile, whereby the mechanical connection is provided; and
at least one first portion of the first electrical circuit, the at least one first portion including one or more first flexible conductors arranged on at least one side of a first flexible and electrically insulating layer, and being arranged between the at least one male profile and the at least one female profile together with a corresponding at least one second portion of the second electrical circuit, the at least one second portion including one or more second flexible conductors arranged on at least one side of a second flexible and electrically insulating layer, whereby the electrical connection is provided by contact between the one or more first flexible conductors and the one or more second flexible conductors when the at least one male profile is inserted into the at least one female profile.

The object is further achieved by the above mentioned second unit according to the characterizing portion of claim 2. The second unit includes a second member of a releasable fastening arrangement arranged for providing:
a mechanical connection of the second unit to a first unit; and
an electrical connection of a second electrical circuit included in the second unit to a first electrical circuit included in the first unit;

characterized by:
at least one female profile included in the second member, the at least one female profile including one or more slots arranged for receiving one or more corresponding at least partially resilient latching arm members included in at least one corresponding male profile of the first unit, when the at least one female profile receives the at least one male profile, whereby the mechanical connection is provided;
at least one second portion of the second electrical circuit, the at least one second portion including one or more second flexible conductors arranged on at least one side of a second flexible and electrically insulating layer, and being arranged between the at least one male profile and the at least one female profile together with a corresponding at least one first portion of the first electrical circuit, the at least one first portion including one or more first flexible conductors arranged on at least one side of a first flexible and electrically insulating layer, whereby the electrical connection is provided by contact between the one or more first flexible conductors and the one or more second flexible conductors when the at least one female profile receives the at least one male profile.

An advantage with these aspects of the invention is that the one or more at least partially resilient latching arm members of the male profile and the one or more corresponding slots of the female profile allows the male profile to be snapped into and snapped out of the female profile. Thereby, providing a releasable connection/locking between the first unit and the second unit, and a solid/reliable contact pressure between the one or more first flexible conductors and the one or more second flexible conductors arranged between the male profile and the female profile.

A further advantage with these aspects of the invention is that by integrating the electrical connection with the mechanical connection, the manufacturing of the units, as well as the installation of the units, can be simplified.

Furthermore, by making the fastening arrangement releasable, the fastening arrangement can be used in a number of applications where the two units are to be temporarily connected to each other. Such a releasable fastening arrangement providing both a mechanical and electrical connection can e.g. be used in the previously mentioned floor application. In this way, the floor or individual floor panels may easily be exchanged. Other applications could e.g. be the fastening of lighting, sensors, and similar objects which require electricity to function to a mounting rack. With a releasable fastening arrangement providing both a mechanical and electrical connection the use of external cables or batteries can be avoided, and the lighting or sensors can easily be moved.

According to an embodiment of the present invention, the electrical connection provides electric power between the first unit and the second unit, the electric power provided through the electrical connection can drive a power consuming part in at least one of the first unit and the second unit.

An advantage with this embodiment of the invention is that the electrical connection provided by the releasable fastening arrangement can be used to supply electric power to a part/component/function in the first unit or second unit which requires electrical power to operate. Thereby, allowing the power consuming part to operate without the need for any external electrical cables/connections or an internal battery.

According to an embodiment of the present invention, the first unit includes a power consuming part being connected to the first electrical circuit and/or the second unit includes a power consuming part being connected to the second electrical circuit.

According to an embodiment of the present invention, the first member includes two male profiles and the second member includes two corresponding female profiles; and the first electrical circuit includes two first flexible conductors arranged on a respective male profile and the second electrical circuit includes two second flexible conductors arranged on a respective female profile.

According to an embodiment of the present invention, one of the first flexible conductors and one of the second flexible conductors have a first electrical potential P1 and the other one of the first flexible conductors and the other one of the second flexible conductors have a second electrical potential P2 different from the first electrical potential P1.

An advantage with these aspects of the invention is that the two male profiles and the two corresponding female profiles can be arranged such that an improved stability and/or strength of the mechanical connection is achieved.

Furthermore, the two first flexible conductors and the two second flexible conductors provides flexibility in providing electric power through the electrical connection.

According to an embodiment of the present invention, a strength of the mechanical connection provided by the releasable fastening arrangement is adapted based on at least one of:
a weight of the first unit or the second unit;
an orientation of the first unit or the second unit; and
an environment in which the releasable fastening arrangement is used.

An advantage with this embodiment of the invention is that the strength of the mechanical connection/coupling, i.e. the solidity/stability of the arrangement and/or the power/force needed for fastening and/or releasing the arrangement, can be adjusted based on characteristics of the units to be connected, as well as the environment in which the releasable fastening arrangement is used.

According to an embodiment of the present invention, the mechanical connection provided by the releasable fastening arrangement is capable of carrying/holding/being loaded with (i.e. is not released by), a force corresponding one to five times the weight of the first unit or the second unit.

According to an embodiment of the present invention, the mechanical connection provided by the releasable fastening arrangement is released by a force corresponding to two to five times the weight of the first unit or the second unit.

An advantage with these embodiments of the invention is that the strength of the mechanical connection/coupling can be adjusted to match the specific implementation/use of the unit assembly, or to match the physical strength of an intended user, such that the intended user is capable to fasten and release the arrangement.

According to an embodiment of the present invention, the at least one male profile includes one in the group:
one at least partially resilient latching arm member arranged for being releasably locked in one slot of the female profile;
two at least partially resilient latching arm members arranged for being releasably locked in two slots of the female profile, respectively.

According to an embodiment of the present invention, the at least one female profile includes one in the group:
one slot arranged for releasably locking one at least partially resilient latching arm member of the male profile; and
two slots arranged for releasably locking two at least partially resilient latching arm members of the male profile, respectively.

According to an embodiment of the present invention, the electrical connection is achieved by a contact pressure between the one or more first flexible conductors and the one or more second flexible conductors being pressed against each other when the at least one male profile has been inserted into the at least one female profile.

According to an embodiment of the present invention, the one or more first and second flexible conductors are arranged on at least one side of the first and second flexible and electrically insulating layers, respectively, as printed electronics.

According to an embodiment of the present invention, the first and second flexible and electrically insulating layers include at least one material in the group of:
plastic;
rubber;
paper; and
textile.

According to an embodiment of the present invention, the first or second unit are at least one building panel in the group of:
a flooring panel including a heat providing layer, the heat providing layer comprising the first or second electronic circuit, respectively;
a wall panel including a heat providing layer, the heat providing layer comprising the first or second electronic circuit, respectively; and
a ceiling panel including a heat providing layer, the heat providing layer comprising the first or second electronic circuit, respectively.

According to an embodiment of the present invention, the releasable fastening arrangement is arranged at least partly at panel coupling means of the building panel, the panel coupling means being arranged for coupling adjacent building panels together.

According to an embodiment of the present invention, the releasable fastening arrangement is arranged at one or more of at least one longitudinal side and at least one end side of the building panel for coupling adjacent building panels together and for creating a joint gap width between the adjacent panels.

According to an embodiment of the present invention, the first or second unit is at least one in the group of:
a store element;
a loudspeaker;
a display;
a lighting device;
a sensor;
a camera;
a wireless device.

The above mentioned object is also achieved by the above mentioned unit assembly. The unit assembly includes at least one of:
a first unit according to any one of claim 1 or 3-11; and
a second unit according to any one of claims 2-11.

### BRIEF DESCRIPTION OF THE DRAWINGS

Embodiments of the invention are described in more detail with reference to attached drawings illustrating examples of embodiments of the invention in which:

FIGS. 1a-b show a first unit according to an embodiment of the invention;

FIGS. 2a-b show a second unit according to an embodiment of the invention;

FIGS. 3a-c show fastening of the releasable fastening arrangement according to an embodiment of the invention;

FIGS. 4a-c show fastening of a releasable fastening arrangement according to an embodiment of the invention;

FIGS. 5a-b show a releasable fastening arrangement according to an embodiment of the invention.

### DETAILED DESCRIPTION OF INVENTION

According to embodiments of the invention a unit including a member of a releasable fastening arrangement is provided. The releasable fastening arrangement is arranged to provide both a mechanical connection and an electrical connection between the unit and another unit with a corresponding member of the releasable fastening arrangement. Furthermore, a unit assembly is provided. The unit assembly includes at least one of a first unit and a second unit according to any of the below described embodiments. The electrical connection provided by the releasable fastening arrangement can provide electrical power from the first unit to the second unit, or vice versa, to drive a power consuming part in the first unit and/or the second unit.

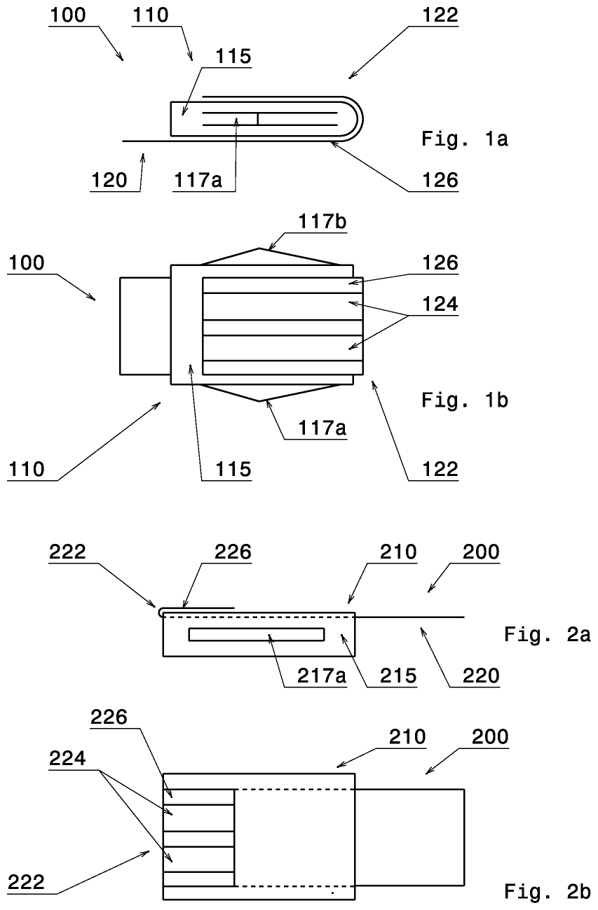

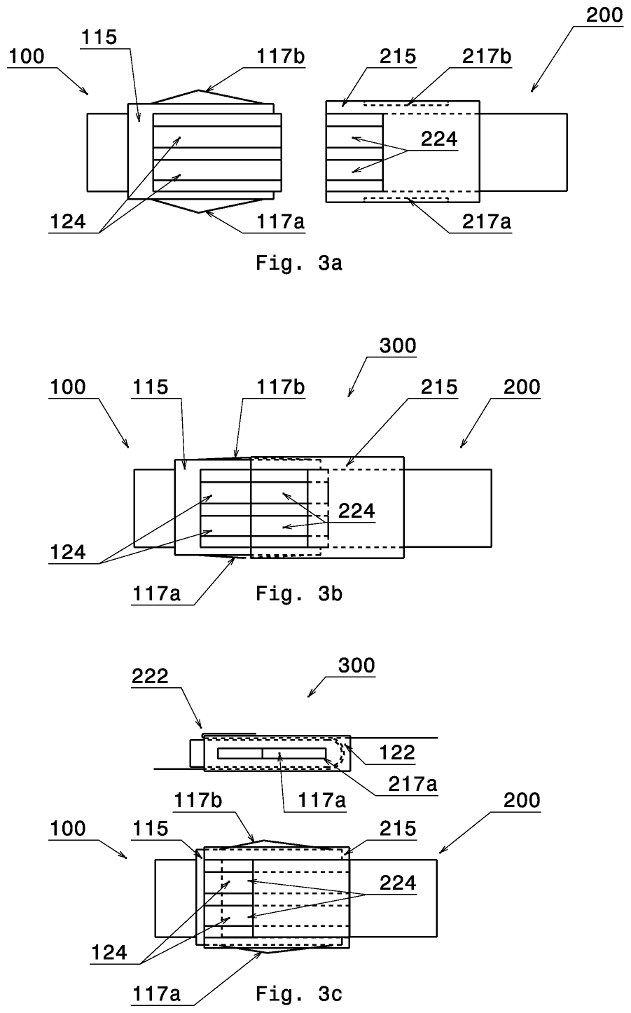

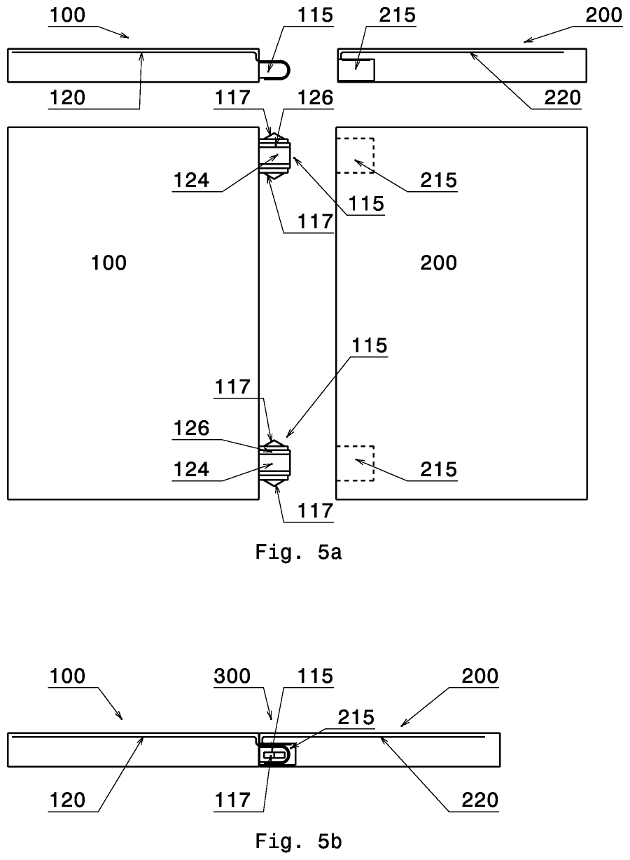

FIGS. 1a-b show a side view and a top view of a first unit 100 according to an embodiment of the invention. The first unit 100 includes a first member 110 of the releasable fastening arrangement 300. The first member 110 may be integrated with or attached to the first unit 100. In the embodiment shown in FIGS. 1a-b, the first member 110 includes one male profile 115. However, the first member 110 may in embodiments include more than one male profile 115, e.g. as shown in FIGS. 5a-b. The male profile 115 includes one or more at least partially resilient latching arm members 117 arranged for engaging with one or more corresponding slots 217 of a corresponding female profile 215 of the releasable fastening arrangement 300, where the female profile 215 is included in a second unit 200 (shown e.g. in FIGS. 2a-b). In the embodiment shown in FIGS. 1a-b, the male profile 115 includes two at least partially resilient latching arm members 117a, 117b. The shape of each latching arm member 117a, 117b is adapted to snap into a corresponding slot 217a, 217b of the female profile 215 such that the male profile 115 is snap-locked to the female profile 215, as will be further described with reference to FIGS. 3a-c and 4a-c. In the embodiment shown in FIGS. 1a-b, the two latching arm members 117a, 117b have a triangular shape extending out from a respective side of the male profile 115, where the respective sides are opposite to each other such that the two latching arm members 117a, 117b are arranged at opposite sides of the male profile 115. However, the invention is not limited to the shape and position of the latching arm members 117a, 117b shown in FIGS. 1a-b. Instead the one or more latching arm members 117 may in embodiments have other shapes and be positioned differently on the male profile 115 than shown in FIGS. 1a-b.

As described above, the male profile 115 in FIGS. 1a-b includes two at least partially resilient latching arm members 117a, 117b arranged to be releasably locked in two slots 217a, 217b of the female profile 215, respectively. In embodiments, the male profile 115 may include one at least partially resilient latching arm member 117 arranged to be releasably locked in one slot 217 of the female profile 215.

The first unit 100 further includes a first electrical circuit 120. The first electrical circuit 120 includes at least one first portion 122 including one or more first flexible conductors 124 arranged on at least one side of a first flexible and electrically insulating layer 126. In embodiments, the one or more first flexible conductors 124 are arranged on at least one side of the first flexible and electrically insulating layer 126 as printed electronics. The first flexible and electrically insulating layer 126 may e.g. include at least one material in the group of plastic, rubber, paper, and textile. The first portion 122 is arranged to cover at least a part of the male profile 115, e.g. be arranged around or to follow at least a part of the contour/circumference of the male profile 115. In the embodiment shown in FIGS. 1a-b, the first portion 122 is arranged around the main part of the contour of the male profile 115, i.e. covers more than half of the contour of the male profile 115. The distance in the FIGS. 1a-b between the first flexible and electrically insulating layer 126 and the male profile 115 is mainly for illustrative purpose. Typically, the first flexible and electrically insulating layer 126 would, at least partly, abut the male profile 115. The first flexible and electrically insulating layer 126 may be loosely arranged relative to the male profile 115 or may be attached to the male profile 115 in one or more locations/points e.g. with fastening means or an adhesive. Furthermore, the one or more first flexible conductors 124 are arranged at least on the side of the first flexible and electrically insulating layer 126 facing away from the male profile 115, as shown in FIG. 1b.

FIGS. 2a-b show a side view and a top view of the second unit 200 according to an embodiment of the invention. The second unit 200 includes a second member 210 of the releasable fastening arrangement 300. The second member 210 may be integrated with or attached to the second unit 200. In the embodiment shown in FIGS. 2a-b, the second member 210 includes one female profile 215. However, the second member 210 may in embodiments include more than one female profile 215, e.g. as shown in FIGS. 5a-b. The female profile 215 includes one or more slots 217 arranged for receiving one or more corresponding at least partially resilient latching arm members 117 included in the corresponding male profile 115 of the releasable fastening arrangement 300 of the first unit 100. In the embodiment shown in FIGS. 2a-b, the female profile 215 includes two slots 217a, 217b arranged for receiving the two corresponding at least partially resilient latching arm members 117a, 117b included in the corresponding male profile 115 shown in FIGS. 1a-b. The shape of each slot 217a, 217b is adapted to receive a corresponding latching arm member 117a, 117b of the male profile 115 such that the male profile 115 is releasably fastened to the female profile 215, as will be further described with reference to FIGS. 3a-c and 4a-c. In the embodiment shown in FIGS. 2a-b, the two slots 217a, 217b have a rectangular shape and constitutes a recess/hole/opening in the side of the female profile 215. However, other shapes and positions of the one or more slots 217 are also possible without deviating from the scope of the invention.

As described above, the female profile 215 in FIGS. 2a-b includes two slots 217a, 217b arranged to releasably lock two at least partially resilient latching arm members 117a, 117b of the male profile 115, respectively. In embodiments, the female profile 215 may include one slot 217 arranged to releasably lock one at least partially resilient latching arm member 117 of the male profile 115.

The second unit 200 further includes a second electrical circuit 220. The second electrical circuit 220 includes at least one second portion 222 including one or more second flexible conductors 224 arranged on at least one side of a second flexible and electrically insulating layer 226. The second portion 222 is arranged to cover at least a part of the female profile 215, e.g. be arranged around or to follow at least a part of the contour/circumference of the female profile 215. In the embodiment shown in FIGS. 2a-b, the second portion 222 is arranged to cover one inner side of the female profile 215 and extend around to a corresponding outer side of the female profile 215. Furthermore, the one or more second flexible conductors 224 are arranged at least on the side of the second flexible and electrically insulating layer 226 facing away from the female profile 215, as shown in FIG. 2b. The second portion 222 may also be arranged to cover other parts of the female profile 215, e.g. two or more inner sides and/or one or more outer sides of the female profile 215.

In the same way as described above for the first electrical circuit 120, the one or more second flexible conductors 224 may be arranged on at least one side of the second flexible and electrically insulating layer 226 as printed electronics, and the second flexible and electrically insulating layer 226 may e.g. include at least one material in the group of plastic, rubber, paper, and textile.

The first member 110 of the releasable fastening arrangement 300 is arranged to provide both a mechanical connection and an electrical connection between the first unit 100 and the second unit 200 including the corresponding second member 210 of the releasable fastening arrangement 300. The mechanical connection and the electrical connection are provided based on the engagement between the at least partially resilient latching arm members 117 of the first member 110 and the slots 217 of the female profile 215. When the male profile 115 is inserted into the female profile 215, the at least partially resilient latching arm members 117 of the first member 110 snaps into the slots 217 of the female profile 215. Thereby, engaging/locking the male profile 115 to the female profile 215. The snap lock function is provided by the at least partially resilient/elastic nature of the latching arm members 117, allowing the latching arm members 117 to be compressed/deformed during the insertion and further relax into the slots 217 of the female profile 215 when inserted. The resilience of the latching arm members 117 may be provided by the latching arm members 117 including, at least partly, one or more elastic material such as e.g. plastic, rubber, composite, wood, or metal.

The electrical connection is provided by contact between the first electrical circuit 120 and the second electrical circuit 220 when the male profile 115 is inserted into the female profile 215. As shown in FIGS. 1a-b, the first electrical circuit 120 of the first unit 100 includes the first portion 122 which in turn includes the one or more first flexible conductors 124 arranged on the first flexible and electrically insulating layer 126. The first portion 122 is arranged to at least partly cover the male profile 115. Furthermore, the one or more first flexible conductors 124 are arranged at least on the side of the first flexible and electrically insulating layer 126 facing away from the male profile 115. In a corresponding way, the second electrical circuit 220 of the second unit 200 includes the second portion 222 which in turn includes the one or more second flexible conductors 224 arranged on the second flexible and electrically insulating layer 226. The second portion 222 is arranged to at least partly cover the female profile 215, as shown in FIGS. 2a-b. Furthermore, the one or more second flexible conductors 224 are arranged at least on the side of the second flexible and electrically insulating layer 226 facing away from the female profile 215. When the at least one male profile 115 is inserted into the at least one female profile 215, the first portion 122 is hence arranged between the male profile 115 and the female profile 215 together with the corresponding second portion 222. The position of the one or more first flexible conductors 124 on the first flexible and electrically insulating layer 126 of the first portion 122 and the position of the one or more second flexible conductors 224 on the second flexible and electrically insulating layer 226 of the second portion 222 are selected such that contact is created between the one or more first flexible conductors 124 of the first portion 122 and the one or more second flexible conductors 224 of the second portion 222, when the male profile 115 has been inserted into the female profile 215. Due to the matching shapes of the male profile 115 and female profile 215, a solid/reliable contact pressure is created between the male profile 115 and female profile 215 when the male profile 115 has been inserted into the female profile 215. As the first portion 122 and the second portion 222 are arranged between the male profile 115 and the female profile 215, the one or more first flexible conductors 124 and the one or more second flexible conductors 224 are pressed against each other by the created contact pressure. Hence, a solid/reliable electrical connection is achieved by the contact pressure between the one or more first flexible conductors 124 and the one or more second flexible conductors 224 being pressed against each other when the male profile 115 has been inserted into the female profile 215.

In embodiments, the first unit 100 and/or the second unit 200 may include at least one power consuming part, i.e. at least one part, component, unit, arrangement, assembly and/or function which requires power/energy/electricity to operate. The electrical connection provided by the releasable fastening arrangement 300 may in this case be used to provide electrical power, i.e. distribute electricity, to the first 100 or second 200 unit and thereby supply electric power to the power consuming part in the first unit 100 or the second unit 200. The provided electrical power may be either alternating current (AC) or direct current (DC). For example, if the first unit 100 includes a power consuming part, the second unit 200 may be connected to an AC or DC electric power supply and may provide electric power to the power consuming part in the first unit 100 through the electrical connection provided by the releasable fastening arrangement 300. The electrical power provided by the second unit 200 through the electrical connection may then be used in the first unit 100 to drive/operate/run the power consuming part. The second unit 200 may be connected directly to the AC or DC electric power supply or be connected to the AC or DC electric power supply via one or more other units, e.g. one or more first 100 and second 200 units.

When the first unit 100 includes a power consuming part, the power consuming part may be connected to the first electrical circuit 120 of the first unit 100 and the second electrical circuit 220 of the second unit 200 may be connected to an electric power supply. Thus, the electrical connection provided by contact between the first electrical circuit 120 and the second electrical circuit 220, when the male profile 115 is inserted into the female profile 215, allows electrical power to be transferred from the electrical power supply through the second unit 200 to the power consuming part in the first unit 100.

When the second unit 200 includes a power consuming part, the power consuming part may be connected to the second electrical circuit 220 of the second unit 200 and the first electrical circuit 120 of the first unit 100 may be connected to an electric power supply. In this case, the electrical connection provided by contact between the first electrical circuit 120 and the second electrical circuit 220 allows electrical power to be transferred from the electrical power supply through the first unit 100 to the power consuming part in the second unit 200.

FIGS. 3a-c show top and side views of the first unit 100 and the second unit 200 during fastening of the releasable fastening arrangement 300 according to an embodiment. FIG. 3a shows the male profile 115 and the female profile 215 in an initial state before being connected. In the shown embodiment, the male profile 115 has two latching arm members 117a, 117b and the female profile 215 has two corresponding slots 217a, 217b. During the insertion of the male profile 115 into the female profile 215, the partial resilience of the latching arm members 117a, 117b allows the two latching arm members 117a, 117b to be pressed towards the sides of the male profile 115 by the female profile 215, as shown in FIG. 3b. When the male profile 115 has been inserted into the female profile 215, the latching arm members 117a, 117b relaxes into the corresponding slots 217a, 217b of the female profile 215, as shown in FIG. 3c. Thereby, the male profile 115 is snap-locked into the female profile 215, creating the mechanical connection between the first unit 100 and the second unit 200.

In the embodiment shown in FIGS. 3a-c, both ends of the latching arm members 117a, 117b have a slight slope relative to the side of the male profile 115. The ends of the latching arm members 117a, 117b may e.g. be arranged at an angle smaller than 45 degrees relative to the side of the male profile 115. Thereby, allowing the latching arm members 117a, 117b to be compressed by the female profile 215 both when the male profile 115 is being inserted into the female profile 215 and when the male profile 115 is being pulled away from the female profile 215. Hence, the male profile 115 can be released from the female profile 215 by pulling the male profile 115 away from the female profile 215, i.e. by a force parallel to the extension direction of the latching arm members 117a, 117b.

As shown in FIG. 3c, once the male profile 115 has been inserted into the female profile 215 the first portion 122 and the second portion 222 are arranged in contact with each other between the male profile 115 and the female profile 215. Thereby, providing the electrical connection between the one or more first flexible conductors 124 of the first portion 122 and the one or more second flexible conductors 224 of the second portion 222.

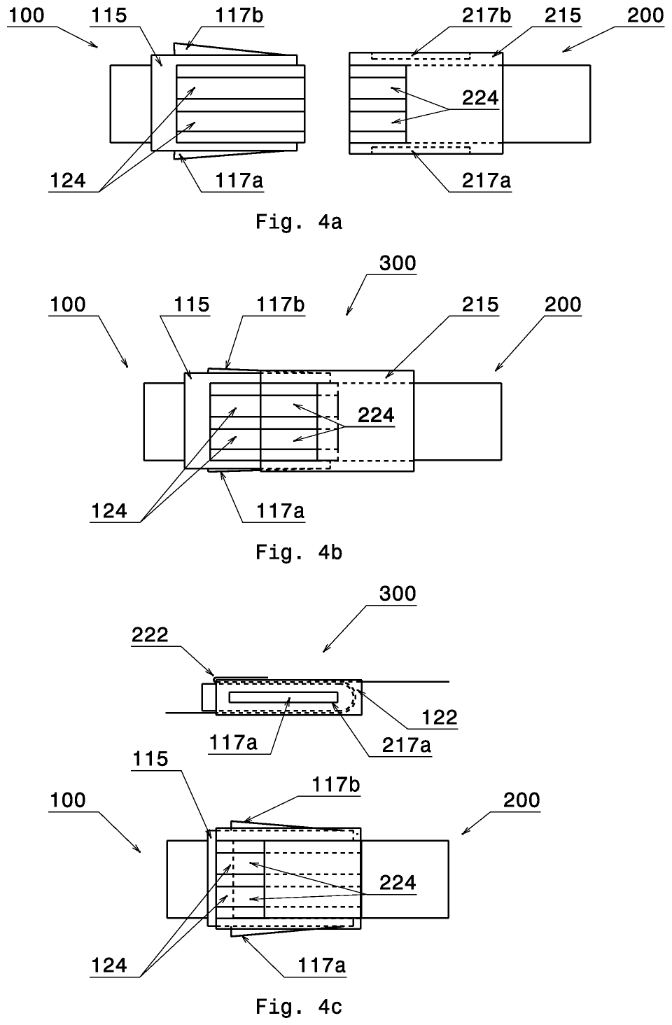

FIGS. 4a-c show top and side views of the first unit 100 and the second unit 200 during fastening of the releasable fastening arrangement 300 according to another embodiment. The embodiment shown in FIGS. 4a-c only differ from the embodiment shown in FIGS. 3a-c in that the two latching arm members 117a, 117b of the male profile 115 have another shape. Instead of the latching arm members 117a, 117b having a slight slope at both ends, one end of the latching arm members 117a, 117b is arranged at a steep angle to the side of the male profile 115, e.g. arranged to be approximately perpendicular to the side of the male profile 115, while the other end of the latching arm members 117a, 117b is arranged at a small angle to the side of the male profile 115, as shown in FIGS. 4a-c. Thereby, the latching arm members 117a, 117b can be compressed by the female profile 215 when the male profile 115 is being inserted into the female 215, as shown in FIG. 4b. However, once inserted, the steep angle of the one end of the latching arm members 117a, 117b prevents the male profile 115 from being released from the female profile 215. In the embodiment shown in FIGS. 4a-c, the male profile 115 can hence not be released from the female profile 215 by just pulling the male profile 115 away from the female profile 215, since the latching arm members 117a, 117b have snapped into the slots 217a, 217b with the steep angle end against one side of the slots 217a, 217b. Instead an external lateral force which compresses the latching arm members 117a, 117b have to be applied while pulling the male profile 115 away from the female profile 215 in order released the male profile 115 from the female profile 215.

According to embodiments of the invention at least one of the first unit 100 and the second unit 200 are a building panel including a heat providing layer, the heat providing layer comprising the first electronic circuit 120 and the second electronic circuit 220, respectively. The building panel may e.g. be a floor panel, a wall panel or a ceiling panel. In such embodiments, the releasable fastening arrangement 300 may provide a mechanical connection and an electrical connection between two adjacent building panels such that the two building panels are mechanically fastened to each other, and electricity is provided between the heat providing layers of the two building panels. The releasable fastening arrangement 300 may be arranged at least partly at panel coupling means of the building panels. The panel coupling means may be arranged for coupling adjacent building panels together and may e.g. be a tongue/groove type of coupling means. Furthermore, the releasable fastening arrangement 300 may be arranged at one or more of at least one longitudinal side and at least one end side of the building panels for coupling adjacent building panels together and for creating a joint gap width between the adjacent panels.

FIGS. 5a-b show side and top views of the releasable fastening arrangement 300 according to an embodiment of the invention. In the embodiment shown in FIGS. 5a-b, the releasable fastening arrangement 300 is arranged at a panel coupling means arranged to couple the first unit 100 to the second unit 200 which may e.g. be building panels. The first member 110 of the first unit 100 includes more than one, in this example two, male profiles 115 and the second member 210 of the second unit 200 includes more than one, in this example two, corresponding female profiles 215. The male profiles 115 of the releasable fastening arrangement 300 is arranged perpendicular to and protruding from an end side and/or a longitudinal side of the first unit 100, while the female profiles 215 of the releasable fastening arrangement 300 is arranged as a recess/opening into an end side and/or a longitudinal side of the second unit 200.

FIG. 5a shows the first unit 100 and the second unit 200 before they are coupled to each other. In FIG. 5b, the first unit 100 is fastened to the second unit 200 by the releasable fastening arrangement 300. Hence, the two male profiles 115 are inserted into the two corresponding female profiles 215, thereby providing the mechanical connection between the first unit 100 and the second unit 200 and the electrical connection between the first electrical circuit 120 of the first unit 100 and the second electrical circuit 220 of the second unit 200. When the first unit 100 and the second unit 200 are building panels, the first electrical circuit 120 and the second electrical circuit 220 may be comprised in a respective heating layer and be used to generate heat in the heating layers.

With reference to FIG. 5a, the first electrical circuit 120 may comprise two first flexible conductors 124 arranged at a respective male profile 115. In a similar way, the second electrical circuit 220 may comprise two second flexible conductors 224 arranged at a respective female profile 215 (not shown in the figures). One first flexible conductor 124 and one second flexible conductor 224 may have a first electrical potential P1 and the other first flexible conductors 124 and the other second flexible conductor 224b may have a second electrical potential P2 different from the first electrical potential P1. The first electrical potential P1 may e.g. be positive. In this case, the second electrical potential P2 may e.g. be negative or zero. Furthermore, when the electrical power being supplied is AC, the first electrical potential P1 and/or the second electrical potential P2 may vary over time.

In the embodiment shown in FIGS. 5a-b, the shape and dimensions of the male profiles 115 and the female profiles 215 are selected such that when the male profiles 115 have been inserted into the female profiles 215 the end sides and/or the longitudinal sides of the first unit 100 and the second unit 200 are in contact with each other, as shown in FIG. 5b. However, in some embodiments the shape and dimensions of the male profiles 115 and the female profiles 215 may instead be selected such that a gap is created between the end sides and/or the longitudinal sides of the first unit 100 and the second unit 200, when the male profiles 115 have been inserted into the female profiles 215. This may e.g. be beneficial in embodiments where the first unit 100 and the second unit 200 are building panels such as tiles or clinkers. The male profile(s) 115 and the female profile(s) 215 can be designed and positioned at the end sides and/or the longitudinal sides of the first unit 100 and the second unit 200, respectively, such that a gap with a fixed joint width is created between the first unit 100 and the second unit 200, i.e. the joint width may then be the same along the full length of the end sides and/or the longitudinal sides of the first unit 100 and the second unit 200.

In embodiments, the second unit 200 may be a rack, shelf, base or similar to which one or more first units 100 can be mounted/connected/fastened using the releasable fastening arrangement 300 according to the invention. The first unit 100 may in such embodiments be any of a store element, a loudspeaker, a display, a lighting device, a sensor, a camera, and a wireless device. In embodiments, the second unit 200 may be a rack e.g. mounted in a ceiling or under a cabinet. The second member 210 of the second unit 200 may include one or more female profiles 215 to which one or more first units 100 including one or more corresponding male profiles 115 can be connected. For example, the second member 210 of the second unit 200 may include a large number of female profiles 215 such that several first units 100 with one or two corresponding male profiles 115 can be mounted to the second unit 200 at different locations along the second unit 200. The first unit 100 may in this case e.g. be a spotlight or a loudspeaker. The second electrical circuit 220 of the second unit 200 may be connected to an electric power supply and hence provide electric power to the first electrical circuit 120 of the first unit 100 through the electric connection provided by the releasable fastening arrangement 300. The provide electric power may be used to operate the first unit 100, e.g. drive a power consuming part in the first unit 100 as previously described. The first unit 100 may e.g. be a lighting device comprising a lamp and the electric power provided from the second unit 200 through the releasable fastening arrangement 300 to the first unit 100 may be used to light the lamp.

The strength of the mechanical connection provided by the releasable fastening arrangement 300 may be adapted based on at least one of a weight of the first unit 100 or the second unit 200, an orientation of the first unit 100 or the second unit 200, and an environment in which the releasable fastening arrangement 300 is used. The orientation of the first unit 100 or the second unit 200 may be an orientation in which the first unit 100 or the second unit 200 mainly extends and may e.g. be a mainly horizontal or vertical direction. Factors in the environment which may affect a desired strength of the mechanical connection may e.g. be vibrations, temperature, and/or humidity.

The strength of the mechanical connection may e.g. be adapted to be higher/stronger when the first unit 100 is arranged to hang from the second unit 200, then when both first unit 100 and the second unit 200 are arranged to be supported by e.g. a floor.

In various embodiments, the strength of the mechanical connection may be adapted by e.g. changing the material and dimensions of the at least one male profile 115 and the at least one female profile 215, as well as by changing the number of male 115 and female 215 profiles.

In embodiments, the mechanical connection provided by the releasable fastening arrangement 300 is capable of carrying, i.e. can hold/withstand and thus not be released by, a force corresponding to one to five times the gravity force related to the weight of the first unit 100 or the second unit 200. The mechanical connection may hence keep the first unit 100 and the second unit 200 connected as long as the first unit 100 and the second unit 200 are not pulled away from each other with a force exceeding a force corresponding to one to five times the weight of the first unit 100 or the second unit 200.

In various embodiments, the mechanical connection provided by the releasable fastening arrangement 300 is released by a force corresponding to two to five times the gravity force related to the weight of said first unit 100 or said second unit 200. In other words, the mechanical connection between the first unit 100 and the second unit 200 can be released by pulling the first unit 100 and the second unit 200 away from each other with a force exceeding a force corresponding to two to five times the weight of the first unit 100 or the second unit 200.

The above given forces are non-limiting examples and, as described above, the strength of the mechanical connection may be adapted based on the weight and/or orientation of the first unit 100 and/or the second unit 200, as well as based on the environment in which the releasable fastening arrangement 300 is used.

1. A first unit including a first member of a releasable fastening arrangement arranged for providing:
a mechanical connection of said first unit to a second unit; and
an electrical connection of a first electrical circuit included in said first unit to a second electrical circuit included in said second unit;
wherein:
said first member has at least one male profile, said at least one male profile including one or more at least partially resilient latching arm members arranged for engaging with one or more corresponding slots of at least one corresponding female profile included in a second member of said second unit when said at least one male profile is inserted into said at least one female profile, whereby said mechanical connection is provided; and
said first electrical circuit has at least one first portion, said at least one first portion including one or more first flexible conductors arranged on at least one side of a first flexible and electrically insulating layer, and being arranged between said at least one male profile and said at least one female profile together with a corresponding at least one second portion of said second electrical circuit, said at least one second portion including one or more second flexible conductors arranged on at least one side of a second flexible and electrically insulating layer, whereby said electrical connection is provided by contact between said one or more first flexible conductors and said one or more second flexible conductors when said at least one male profile is inserted into said at least one female profile.

2. A second unit including a second member of a releasable fastening arrangement arranged for providing:
a mechanical connection of said second unit to a first unit; and
an electrical connection of a second electrical circuit included in said second unit to a first electrical circuit included in said first unit;
wherein:
said second member includes at least one female profile, said at least one female profile including one or more slots arranged for receiving one or more corresponding at least partially resilient latching arm members included in at least one corresponding male profile of said first unit, when said at least one female profile receives said at least one male profile, whereby said mechanical connection is provided;
said second electrical circuit has at least one second portion, said at least one second portion including one or more second flexible conductors arranged on at least one side of a second flexible and electrically insulating layer, and is arranged between said at least one male profile and said at least one female profile together with a corresponding at least one first portion of said first electrical circuit, said at least one first portion including one or more first flexible conductors arranged on at least one side of a first flexible and electrically insulating layer whereby said electrical connection is provided by contact between said one or more first flexible conductors and said one or more second flexible conductors when said at least one female profile receives said at least one male profile.

3. The first or second unit as claimed in claim 1, wherein said at least one male profile includes one in the group:
one at least partially resilient latching arm member arranged for being releasably locked in one slot of said female profile;
two at least partially resilient latching arm members arranged for being releasably locked in two slots of said female profile, respectively.

4. The first or second unit as claimed in claim 1, wherein said at least one female profile includes one in the group:
one slot arranged for releasably locking one at least partially resilient latching arm member of said male profile; and
two slots arranged for releasably locking two at least partially resilient latching arm members of said male profile, respectively.

5. The first or second unit as claimed in claim 1, wherein said electrical connection is achieved by a contact pressure between said one or more first flexible conductors and said one or more second flexible conductors being pressed against each other when said at least one male profile has been inserted into said at least one female profile.

6. The first or second unit as claimed in claim 1, wherein said one or more first and second flexible conductors are arranged on at least one side of said first and second flexible and electrically insulating layers, respectively, as printed electronics.

7. The first or second unit as claimed in claim 1, wherein said first and second flexible and electrically insulating layers include at least one material in the group of:
plastic;
rubber;
paper; and
textile.

8. The first or second unit as claimed in claim 1, wherein the first or second unit are at least one building panel in the group of:
a flooring panel including a heat providing layer, the heat providing layer comprising said first or second electronic circuit, respectively;
a wall panel including a heat providing layer, said heat providing layer comprising said first or second electronic circuit, respectively; and
a ceiling panel including a heat providing layer, said heat providing layer comprising said first or second electronic circuit, respectively.

9. The first or second unit as claimed in claim 8, wherein said releasable fastening arrangement is arranged at least partly at panel coupling means of said building panel, said panel coupling means being arranged for coupling adjacent building panels together.

10. The first or second unit as claimed in claim 8, wherein said releasable fastening arrangement is arranged at one or more of at least one longitudinal side and at least one end side of said building panel for coupling adjacent building panels together and for creating a joint gap width between said adjacent panels.

11. The first or second unit as claimed in claim 1, wherein said first or second unit is at least one in the group of:
a store element;
a loudspeaker;
a display;
a lighting device;
a sensor;
a camera;
a wireless device.

12. (canceled)
